(19) United States
(12) Patent Application Publication
(10) Pub. No.: US 2005/0206760 A1
(43) Pub. Date: Sep. 22, 2005

(54) Voltage controller and voltage control method for charge-coupled device

(75) Inventor: Yoshihito Higashitsutsumi, Mizuho-shi (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 11/080,687

(22) Filed: Mar. 15, 2005

(30) Foreign Application Priority Data
Mar. 17, 2004 (JP) 2004-076562

(51) Int. Cl. H04N 5/335

(52) U.S. Cl. 348/294

(57) ABSTRACT

A voltage controller for a charge-coupled device is capable of controlling a voltage to be applied to transfer electrodes in accordance with intensity of light incident on pixels to change potential of a transfer channel area, along which information charges are transferred, and a semiconductor interface below the transfer electrodes during image capture. Using this voltage controller enables an improved quality image to be obtained from a charge-coupled device.

### CROSS-REFERENCE TO RELATED APPLICATION

The entire disclosure of Japanese Patent Application No. 2004-76562 including the specification, claims, drawings, and abstract is incorporated herein by reference.

### BACKGROUND OF THE INVENTION

1. Field of the Invention

The present invention relates to a voltage controller and a voltage control method for controlling a voltage to be applied to a transfer electrode in a charge-coupled device, and further relates to an image capture apparatus including such a voltage controller.

2. Description of the Related Art

The quality of an image captured by a solid state semiconductor image capturing device including a charge-coupled device correlates with the ratio of the amount of information charges obtained by photoelectric conversion to the amount of random noise. The brightness range of a subject, over which an image can be captured by the solid state semiconductor image capturing device, mainly depends on the strength of the saturation signal. For example, when an image of a low brightness subject in a dark environment, such as an a poorly lit room or outdoors at night, is to be captured, the information charge obtained by photoelectric conversion is relatively small. Therefore, because the relative ratio of dark current noise to the information charge is increased, the SN ratio (signal to noise ratio) of the image signal deteriorates. On the other hand, when an image of a high brightness subject is to be captured under bright conditions, such as outdoors under sunshine, the information charges obtained by photoelectric conversion is large. As a result, the information charge is likely to exceed the storage capacity and cause “white out”.

The occurrence of dark current noise will be described below. FIG. 1 conceptually shows a cross-sectional structure of an image capture area in a charge-coupled device. A p well 202 is formed on an n-type Si substrate 200. Transfer electrodes φ1 to φ4 (each clock applied to each corresponding transfer electrode is referred to by the same name as the corresponding transfer electrode) are arranged on the p well 202, and an n layer 204 is formed below each transfer electrode so that an npn structure is formed. An insulating Si oxide film is interposed between a surface of the substrate 200 and the transfer electrodes.

In general, when a charge-coupled device having a cross-sectional structure as described above is used to capture an image, a negative voltage is applied to the transfer electrodes φ1 and φ3 to electrically separate adjacent pixels. A positive voltage called an “on-gate voltage” is applied to the transfer electrodes φ2 and φ4 to cause information charges to be stored. Potential profiles taken along lines A-A′ and B-B′ in FIG. 1 during the application of an on-gate voltage are shown in FIG. 2. Electric charges are stored in a potential well (with a depth of Don) located along line B-B′ below the gate φ2. Because the potential along line A-A′ is higher than the potential along line B-B′ at any position in the X direction, the gates φ1 and φ3 enable separation of electric charges. Because a potential well is continuously formed in a depletion layer formed at an interface between SiO₂ and Si below a gate, information charges generated from an interface state level are stored in the potential well. Due to accumulation of electric charges that have no relationship with information charges, dark current noise may cause white noise, resulting in deterioration of the SN ratio of the image signal.

With this being the situation, as a method for suppressing the occurrence of a dark current in order to improve the SN ratio of an image signal obtained during image capture of a low brightness subject, a method of driving a charge-coupled device (hereinafter, referred to as “CCD”) by “all-gates-pinning” (hereinafter, referred to as “AGP”) is known.

AGP driving and its effect will be described below. FIG. 3 conceptually shows a cross-sectional structure of an image capture area in a charge-coupled device. A p well 302 is formed on an n-type Si substrate 300. Transfer electrodes φ1 to φ4 (the clocks applied to each corresponding transfer electrode are referred to by the same name as the corresponding transfer electrode) are arranged on the p well 302, and an n layer 304 is formed below each transfer electrode so that an npn structure is formed. An insulating Si oxide film is interposed between a surface of the substrate 300 and the transfer electrodes. A difference from the structure shown in FIG. 1 is in the distribution of an impurity. An n⁺ layer 306 is formed below the transfer electrode φ1. The impurity concentration of the n⁺ layer 306 is higher than that of the n layer 304. This difference causes a difference in the magnitude of a gate voltage applied during image capture.

In a CCD having a cross-sectional structure as described above, when a voltage to be applied to a transfer electrode (gate voltage) is zero, because of the energy difference of electrons at the Fermi level between the metal transfer electrodes and the semiconductor Si substrate 300, the energy band of Si at the interface of the Si oxide film is bent to form a depletion layer. By changing the voltage applied to the transfer electrodes, it is possible to change the manner in which the energy band of Si is bent. A transfer electrode voltage that causes the energy band of Si at the interface of the Si oxide film to be flat is referred to as a “flat band voltage”. The AGP driving is a driving method in which a flat band voltage is applied to the transfer electrodes.

Potential profiles taken along lines A-A′ and B-B′ in FIG. 3 during the application of a flat band voltage are shown in FIG. 4. The distribution of impurities is designed so that the potential decreases, as shown by A-A1-A, uniformly from the interface to the inside of the Si substrate when a voltage for separation of pixels is applied to the transfer electrodes φ1 and φ3 and a potential well (with a depth of D_{AGP}) shown by B-B0-B1 is formed to enable storage of electric charges when a voltage that causes storage of electric charges is applied to the transfer electrodes φ2 and φ4.

The AGP driving is performed by applying a flat band voltage to the transfer electrodes during storage of electric charges so that the interface between the Si oxide film and the Si substrate below the transfer electrodes is brought into a non-depleted state, and, in other words, so that the interface is brought into a pinned state. Therefore, because a dark current generated from the interface is neutralized by a group of holes formed near the interface, accumulation of electric charges from the interface state level into the potential well formed within the substrate is avoided. As a result, occurrence of white noise is suppressed. Further, by employing the AGP driving, not only occurrence of a dark current can be suppressed in each individual pixel, but unevenness in dark currents generated from a plurality of pixels included in the CCD can also be reduced.

As described above, occurrence of white noise can be suppressed by the AGP driving. However, the depth D_{AGP} of a potential well formed during the AGP driving is less than the depth Dₒₙ of a potential well formed during the on-gate driving. In other words, the level of saturation to which information charges can be stored in a potential well decreases. Therefore, in cases wherein strong light from the sun, high intensity lighting, or the like is incident on pixels, sufficient gradations of a signal cannot be obtained because information charges will overflow the potential wells. As a result, an image signal thus obtained has a reduced dynamic range. In addition, for example, so-called “white out” or the like may occur, and the quality of an image may be reduced disadvantageously.

### SUMMARY OF THE INVENTION

According to one aspect of the present invention, there is provided a voltage controller for a charge-coupled device having pixels provided with transfer electrodes, wherein the charge-coupled device generates and stores information charges in accordance with intensity of light incident on the pixels during image capture, transfers the information charges through application of a voltage to the transfer electrodes during transfer, and outputs an image signal in accordance with an amount of the information charges, wherein the voltage is controlled in accordance with the intensity of light incident on the pixels to change potential of a transfer channel area, along which the information charges are transferred, and a semiconductor interface below the transfer electrodes during image capture.

According to another aspect of the present invention, there is provided an image capture apparatus comprising a charge-coupled device having transfer electrodes to which a voltage controlled by the voltage controller is applied and signal processing means including a gain adjustable amplifier and an integrator, wherein the gain adjustable amplifier amplifies a signal output from the charge-coupled device, and the integrator receives a signal output from the amplifier and outputs a gain signal to the amplifier to control signal strength of the signal output from the amplifier to a predetermined level, wherein the voltage controller receives the gain signal, and controls the voltage based on the gain signal that is a signal corresponding to the intensity of light incident on the pixels.

According to still another aspect of the present invention, there is provided an image capture apparatus comprising a charge-coupled device having transfer electrodes to which a voltage controlled by the voltage controller is applied and signal processing means including a gain adjustable amplifier and an integrator, wherein the gain adjustable amplifier amplifies a signal output from the charge-coupled device, and the integrator receives a signal output from the amplifier and outputs a gain signal to the amplifier to control signal strength of the signal output from the amplifier to a predetermined level, wherein the voltage controller receives the gain signal, and controls the voltage based on a level of the gain signal that is a signal corresponding to the intensity of light incident on the pixels to perform switching between the all-gates-pinning driving and the on-gate driving.

According to still another aspect of the present invention, there is provided a voltage control method for a charge-coupled device having pixels provided with transfer electrodes, wherein the charge-coupled device generates and stores information charges in accordance with intensity of light incident on the pixels during image capture, transfers the information charges through application of a voltage to the transfer electrodes during transfer, and outputs an image signal in accordance with an amount of the information charges, the voltage control method comprising steps of obtaining information regarding the intensity of light incident on the pixels; and controlling the voltage in accordance with the obtained information regarding the intensity of incident light to change potential of a transfer channel area, along which the information charges are transferred, and a semiconductor interface below the transfer electrodes during image capture.

### BRIEF DESCRIPTION OF THE DRAWINGS

A preferred embodiment of the present invention will be described in further detail based on the following drawings, wherein:

FIG. 1 conceptually shows a cross-sectional structure of an image capture area in a charge-coupled device;

FIG. 2 shows potential profiles taken along lines A-A′ and B-B′ in FIG. 1 during the application of an on-gate voltage;

FIG. 3 conceptually shows a cross-sectional structure of an image capture area in a charge-coupled device that performs AGP driving;

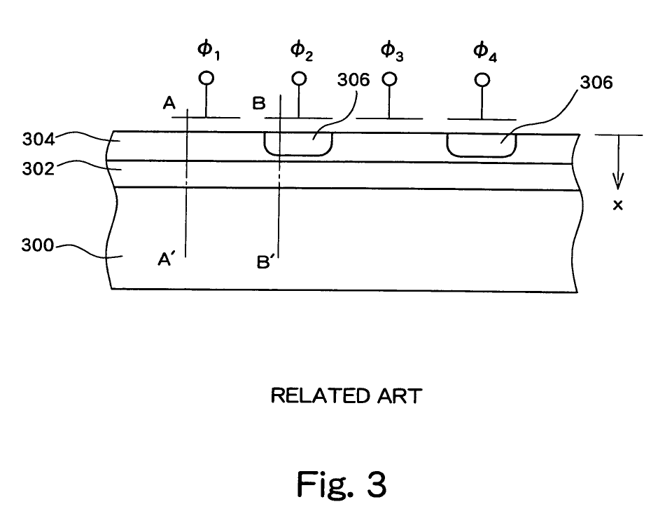

FIG. 4 shows potential profiles taken along lines A-A′ and B-B′ in FIG. 3 during the application of a flat band voltage;

FIG. 5 is a block diagram showing a structure of components connected to a CCD 10 in an image capture apparatus 100 according to a preferred embodiment of the present invention; and

FIGS. 6A to 6C show timing of switching between the AGP driving and the on-gate driving in accordance with change in brightness of a subject over time.

### DESCRIPTION OF PREFERRED EMBODIMENT

A preferred embodiment for carrying out the present invention (hereinafter, referred to as an “embodiment”) will be described below with reference to the drawings.

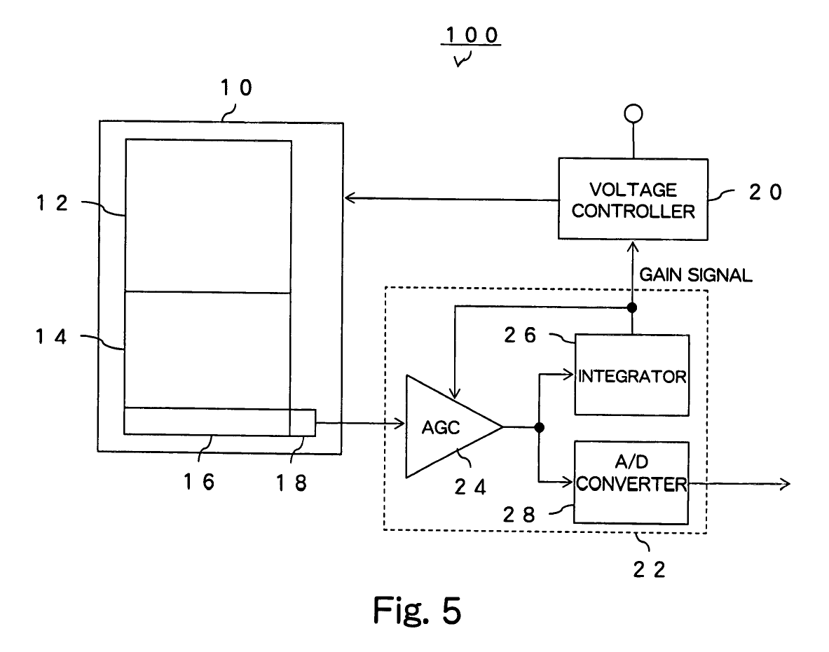

FIG. 5 is a block diagram showing a structure of components connected to a CCD 10 in an image capture apparatus 100 according to an embodiment of the present invention. The image capture apparatus 100 includes the CCD 10, an analog front-end circuit (AE) 22, and a voltage controller 20. In response to incident light collected through an optical system (not shown) including a lens, the CCD 10 generates an image signal by photoelectric conversion. As a preceding stage for performing digital signal processing on the image signal received from the CCD 10, the analog front-end circuit (AE) 22 performs analog signal processing. In response to a signal generated from the AE 22, the voltage controller 20 drives the CCD 10. The CCD 10 has an electronic shutter function for controlling photoelectric conversion.

The CCD 10 includes pixels having transfer electrodes. During image capture, the CCD 10 generates and stores information charges in accordance with the intensity of light incident on the pixels. During transfer, the CCD 10 transfers the information charges through the application of a voltage to the transfer electrodes, and outputs an image signal in accordance with the amount of electric charge. In the present embodiment, the CCD 10 can be of a frame transfer (FT) type. The frame transfer type CCD 10 includes an image capture area 12 that performs photoelectric conversion and vertical transfer, a storage area 14 that stores electric charges vertically transferred from the image capture area 12, a horizontal register 16 that sequentially and horizontally transfers the electric charges stored in the storage area 14, and an output section 18 that converts the transferred electric charges to a voltage signal.

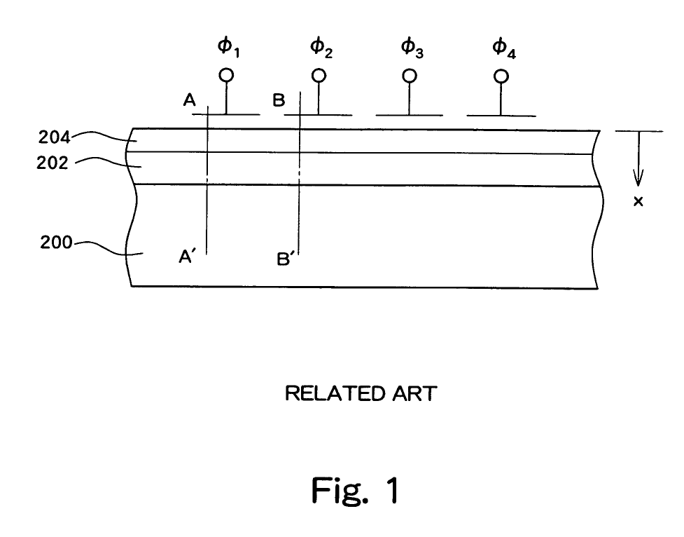

The image capture area 12 and the storage area 14 include a plurality of vertical shift registers extending in a vertical direction (corresponding to the longitudinal direction of the CCD 10 shown in FIG. 1). The vertical shift registers include channel areas, along which information charges are transferred, and transfer electrodes crossing the channel areas. Each bit of the vertical shift registers included in the image capture area 12 functions as one of light receiving pixels. Each bit of the vertical shift registers included in the storage area 14, which is shielded from light, functions as one of storage pixels that store information charges.

A channel area below at least one transfer electrode included in one pixel of the image capture area 12 is doped with a p-type or n-type impurity. The channel area forms a potential barrier. Such potential barriers are formed in some areas but not in other areas so that shallow potential wells are formed. The concentration of the impurity is selected so that the energy band at the interface can be made flat through the application of a voltage (flat band voltage) to the transfer electrodes, as will be described below.

The transfer electrodes of the CCD 10 are electrically connected to the voltage controller 20, to which power is supplied from a power source. The voltage controller 20 controls the image capture, vertical transfer, and horizontal transfer of the CCD 10 by changing the voltage to be applied to the transfer electrodes of the CCD 10 in accordance with a predetermined control signal, which will be described below. The transfer electrodes are arranged on a semiconductor with a gate insulating film being interposed between the semiconductor and the electrodes.

The output section 18 of the CCD 10 is electrically connected to the AE 22. The AE 22 includes an auto gain control amplifier (AGC) 24, an integrator 26, and an A/D converter 28. The AGC 24 comprises gain controllable amplifying means that receives an output signal from the output section 18 and amplifies the received signal so that the input level of an image signal to be input to a following stage, i.e., the A/D converter, reaches a predetermined level. The integrator 26 receives an output signal from the AGC 24, integrates the received signal, and generates a gain signal in accordance with the signal strength of a signal output from the AGC 24. The A/D converter 28 comprises A/D conversion means that receives an output signal from the AGC 24 and converts the received signal to a digital signal. The digital signal obtained by A/D conversion is transmitted to a following stage, i.e., a digital signal processor (DSP) that performs image signal processing. Preferably, the AE 22 may further comprise sampling means such as a correlated double sampling (CDS) circuit that cancels noise included in a signal to be input to the AGC 24 in order to obtain only a signal component.

An output terminal of the integrator 26 is electrically connected to the amplifying means of the AGC 24. The gain of the amplifying means of the AGC 24 is controlled based on a gain signal output from the integrator 26 so that the signal strength of an output signal from the AGC 24 is adjusted to a predetermined level. For example, when an image of a dark (low brightness) subject is captured, because the amount of charges obtained by photoelectric conversion in the image capture area 12 of the CCD 10 is small, the strength of an output signal output from the output section 18 is small. In such cases, the AGC 24 amplifies the signal strength in accordance with a gain signal supplied from the integrator 26 so that the strength of a signal input to the A/D converter 28 is adjusted to a predetermined level. Thus, high-precision analog-to-digital conversion can be performed in the A/D converter 28.

The gain signal is a signal to control the gain so that the output from the AGC 24 is maintained at a constant level, and is a signal generated in accordance with the strength of an output from the CCD 10. In other words, the gain signal is a signal generated in accordance with the intensity of light incident on the pixels of the image capture area 12 of the CCD 10.

The voltage controller 20 is electrically connected to an output terminal of the integrator 26, and receives the gain signal. The present invention is characterized in that the voltage controller 20 controls the voltage to be applied to the transfer electrodes during image capture in accordance with the intensity of light incident on the pixels. By changing the voltage applied to the transfer electrodes, it is possible to change the potential of the transfer channel areas and the interface between the semiconductor and the insulating film below the transfer electrodes.

When a subject is so dark that the intensity of light incident on the pixels of the CCD 10 is less than a predetermined threshold light intensity, the voltage controller 20 applies a flat band voltage to all the transfer electrodes included in the pixels of the image capture area 12 in the CCD 10. The AGP driving is performed by applying a flat band voltage to all the transfer electrodes so that the interface between the Si oxide film and the Si substrate below the transfer electrodes is brought into a non-depleted state, and, in other words, so that the interface is brought into a pinned state. Therefore, because a dark current generated from the interface is neutralized by a group of holes formed near the interface, accumulation of electric charges from the interface state level into the potential wells formed within the substrate is avoided, and occurrence of white noise is suppressed. Further, not only occurrence of a dark current can be suppressed in each individual pixel, but unevenness in dark currents generated from a plurality of pixels included in the CCD can also be reduced.

Information charges stored in the potential wells during a period of image capture are transferred from the image capture area 12 to the storage area 14 during a period of transfer. During transfer, the voltage controller 20 applies a predetermined clock voltage to the transfer electrodes so that the depths of the potential wells are sequentially changed.

On the other hand, when a subject is so bright that a high intensity of light is incident on the pixels of the CCD 10, many electric charges are generated in the transfer channel areas through photoelectric conversion during image capture. If the amount of information charges generated exceeds the level of saturation to which electric charges can be stored in a potential well, the dynamic range of an image signal is reduced because gradation information cannot be obtained. As a result white out or the like is caused, resulting in degradation of image quality.

In such cases, when the intensity of light incident on the pixels of the CCD 10 exceeds a predetermined threshold light intensity, the voltage controller 20 applies a voltage greater than a flat band voltage to at least one transfer electrode included in each pixel. Thus, the on-gate driving is performed to form potential wells in the channel areas of the pixels. In the on-gate driving, the capacity of storage of information charges in a potential well formed below the transfer electrodes is larger than that during the AGP driving. Therefore, because, during the on-gate driving, more information charges can be stored than during the AGP driving, the level of saturation of storage of information charges is increased. Thus, the on-gate driving provides sufficient gradations and improves the dynamic range of an image signal even for a bright subject for which, when the AGP driving is employed, saturation of information charges occurs and gradation information cannot be obtained. As a result, occurrence of white out or the like can be suppressed, and the quality of an image can be improved.

During the on-gate driving, because the interface of the semiconductor is not in a pinned state, the amount of occurrence of dark current is greater than during the AGP driving. However, because the subject is bright, the number of information charges is greater than the number of dark current charges. Further, because the gain of the AGC 24 is small, a dark current component is not noticeable in image information.

In the image capture apparatus 100 according to the present embodiment, under a condition in which the subject is so dark that the gain of the AGC is large and a dark current component is noticeable, occurrence of dark current is suppressed, and, when the subject is so bright that saturation of information charges is likely to occur, the capacity of storage of information charges is increased. Thus, a high quality image can be captured over a wide range of brightness.

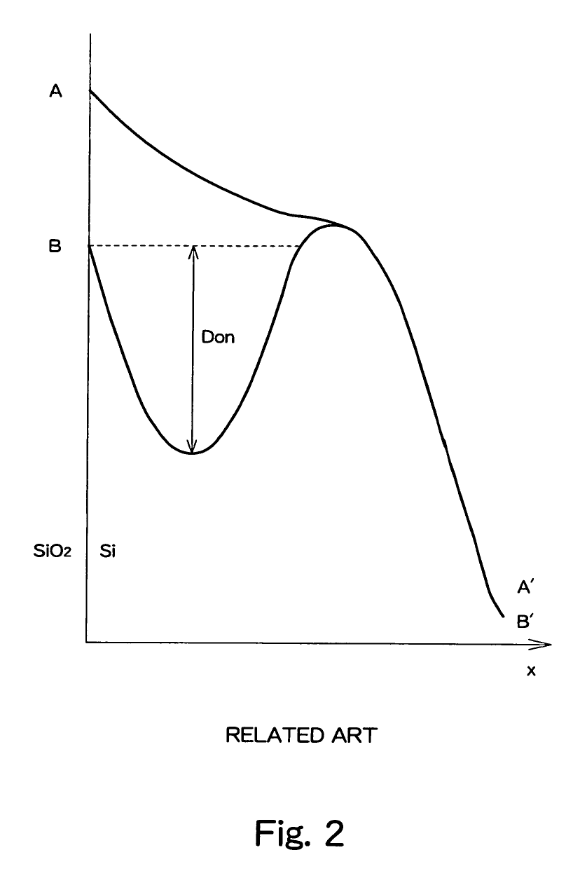

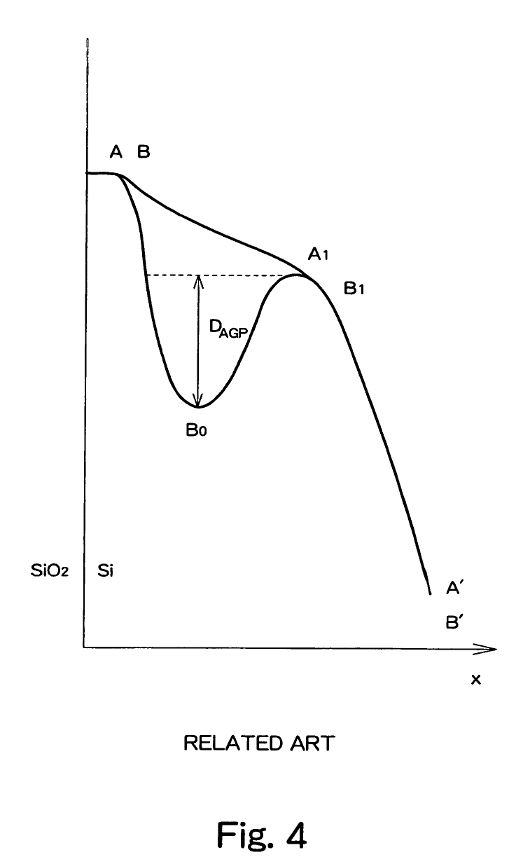

Next, the distribution of concentration of an impurity in the channel areas extending below the transfer electrodes in the image capture area 12 of the CCD 10 will be described. The distribution of concentration of an impurity is selected so that, during the AGP driving in which a flat band voltage is applied to the transfer electrodes, a potential well is formed at a position slightly inside the substrate from the surface of the Si substrate below at least one transfer electrode included in each pixel, and, through the application of a voltage to other transfer electrodes, the potential decreases, as shown by line A-A1-A′ in FIG. 4, uniformly from the surface to the inside of the Si substrate to cause separation of electric charges. Various combinations of distributions of concentration of an impurity and a flat band voltage satisfy the above-described conditions, as is obvious to those skilled in the art. Further, as can be understood, because the distribution of concentration of an impurity is relative, the present embodiment can be carried out irrespective of the type of electrical conductivity of the impurity as long as an obtained distribution of concentration of the impurity is such that potential profiles as shown in FIGS. 2 and 4 are obtained.

Although the image capture apparatus 100 according to the present embodiment is configured to apply a flat band voltage to all transfer electrodes when the intensity of incident light is less than a predetermined threshold light intensity, the voltage to be applied is not limited to a voltage that causes the energy band of Si at the interface of the Si oxide film to be completely flat, but may be a voltage that causes the gradient of the energy band of Si at the interface of the Si oxide film to be smaller than in cases where a zero voltage is applied. Even when such a voltage is applied, a dark current can be suppressed to a greater extent than when a zero voltage is applied. The voltage to be applied is determined based on the depth of a potential well required of the CCD 10, i.e., the capacity of storage of information charges, and the permissible amount of dark current. Similarly, the voltages to be applied during the on-gate driving to the transfer electrodes in the pixels are also determined as appropriate in accordance with the full well capacity required of the CCD 10.

Although the voltage controller 20 is configured to receive, as a control signal, a gain signal generated for controlling the gain of the AGC 24, the control signal for the voltage controller 20 is not limited to a gain signal, but may be any signal that corresponds to the intensity of light incident on the pixels. For example, the image capture apparatus 100 may include, separate from the image capturing device, a light intensity detector for generating a signal corresponding to the intensity of light incident on the pixels, and, based on that signal, the voltage controller 20 may control the voltage to be applied to the transfer electrodes.

Next, the threshold light intensity as a threshold at which the voltage controller 20 switches between the AGP driving and the on-gate driving will be described below. The threshold light intensity is determined based on the characteristics of the CCD 10 and the A/D converter 28 of the AE 22, the permissible ratio of dark current noise in an image signal, the saturation limit brightness, or the like according to the specifications or the like required of the image capture apparatus 100.

In order for the A/D converter 28 in the AE 22 to be able to perform high-precision analog-to-digital conversion, it is preferable that an input level signal to the A/D converter 28 is greater than a maximum input level signal that is an input level signal corresponding to a maximum output level. Thus, the dynamic range of the A/D converter 28 can be utilized effectively. In addition, the level of an input level signal to the A/D converter 28 can be set to a level determined by adding an additional margin to the maximum input level so that unevenness in levels of saturation of the pixels can be eliminated.

The AGC 24 amplifies an output signal fed from the CCD 10, and inputs the amplified signal to the A/D converter 28. On the other hand, the maximum output level of the CCD 10 is determined in accordance with the level of saturation of the image capture area 12. Therefore, the dynamic range of the A/D converter 28 can be utilized effectively through the AGP driving if the following condition is satisfied:
B*G>C+a (1)
wherein “B” is a maximum output level of the CCD 10 obtained during the AGP driving, “G” is an amplification gain of the AGQ 24, “C” is a maximum input level of the A/D converter 28, and “a” is an amount of offset margin. On the other hand, when the subject is bright and “G” is small, the condition (1) is not satisfied. In such cases, it is preferable that switching to the on-gate driving is performed.

Therefore, it is preferable that “C+a” is used as a signal level corresponding to the threshold light intensity at which switching between the AGP driving and the on-gate driving is performed.

Further, in order to suppress a hunting phenomenon caused by a transition between the AGP driving and the on-gate driving, it is preferable that the level of transition from the AGP driving to the on-gate driving and the level of transition from the on-gate driving to the AGP driving are set to be different. By modifying the above condition (1) using different amounts of offset margin “a” and “b” (a>b), the levels can be set such that a transition from the on-gate driving to the AGP driving is performed under the following condition:
B*G>C+a (1)
and such that a transition from the AGP driving to the on-gate driving is performed under the following condition:
B*G<C+b (2)

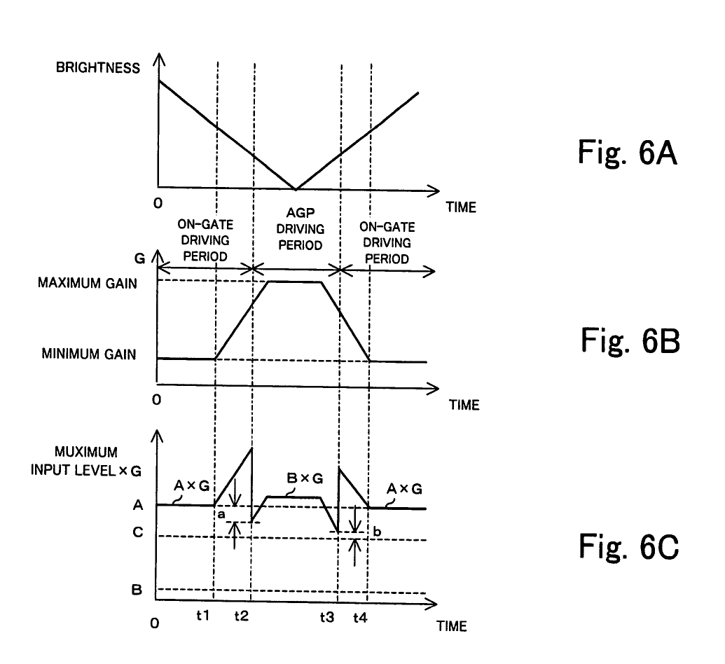

FIGS. 6A to 6C show timing of switching between the AGP driving and the on-gate driving in accordance with change in brightness of a subject over time. FIG. 6A is a plot of the brightness of a subject, in which the horizontal axis represents time and the vertical axis represents brightness. FIG. 6B is a plot of the amplification gain “G” of the AGC 24, in which the horizontal axis represents time. FIG. 6C is a plot of the maximum input level of the A/D converter 28, in which the horizontal axis represents time. The time axes in FIGS. 6A to 6C are aligned with each other. The maximum output level obtained during the on-gate driving is shown by “A”, the maximum output level obtained during the AGP driving is shown by “B”, and the maximum input level of the A/D converter 28 is shown by “C”. Because of the difference in the storage capacity between during the on-gate driving and during the AGP driving, “A” is greater than “B” (A>B). The levels of “A” and “B” are known in advance from the specifications of the CCD 10.

As shown in FIG. 6A, it is assumed that the brightness of the subject is highest at an initial state (time 0), decreases with time, and later increases again.

At the initial state, because the condition (2) is satisfied, the voltage controller 20 drives the transfer electrodes of the CCD 10 by the on-gate driving. At this time, “G” is set to a minimum gain. As shown in FIG. 6C, the maximum input level of the A/D converter 28 is the level of saturation “A” obtained during the on-gate driving. In this state, in order to reduce the amount of light incident on the pixels of the CCD apparatus 100 per unit time, the electronic shutter of the image capture apparatus 100 is adjusted to provide a short exposure time. The exposure time of the electronic shutter is determined based on, for example, “G” and an input level to the A/D converter 28.

As the subject becomes darker over time, the electronic shutter is adjusted to extend the exposure time to increase the amount of light incident on the pixels. At time t1, at which the subject reaches a predetermined brightness, the electronic shutter is full open.

When the subject becomes still darker, the AGC 24 starts to operate so that the gain “G” as shown in FIG. 6B gradually increases from the minimum gain. At time t2, at which the level obtained by multiplying the maximum output level “B” obtained during the AGP driving by the gain “G”, that is, the level “B* G”, becomes greater than “C+a” including the first offset margin “a”, switching from the on-gate driving to the AGP driving is performed.

When the subject becomes still darker, the gain of the AGC 24 reaches the maximum gain. After that, even when the subject becomes further darker, the level “B*G” is no longer affected by the brightness, and is maintained at a constant level, as shown in FIG. 6C.

Then, as the brightness of the subject becomes higher, the gain of the AGC 24 decreases from the maximum gain, as shown in FIG. 6B. At time t3, at which the level obtained by multiplying the maximum output level “B” obtained during the AGP driving by the gain “G”, that is, the level “B*G”, becomes smaller than “C+b” including the second offset margin “b”, as shown in FIG. 6C, switching from the AGP driving to the on-gate driving is performed.

It is preferable that switching between the AGP driving and the on-gate driving is performed at the time of switching between frames at which switching from capturing an image for one frame to capturing an image for another frame is performed. By simultaneously performing switching between the AGP driving and the on-gate driving and switching between frames, it is possible to accurately switch the operation in accordance with the brightness of a subject without causing the signal strength to be changed in one frame.

In the image capture apparatus 100 according to the present embodiment, because different levels for switching between the AGP driving and the on-gate driving are used for transition from the on-gate driving to the AGP driving and for transition from the AGP driving to the on-gate driving, a hunting phenomenon caused by switching can be suppressed.

Although, in the present embodiment, the offset margins “a” and “b” are set such that “a” is greater than “b” (a>b), a hunting phenomenon can similarly be suppressed by setting the offset margins such that “a” is smaller than “b” (a<b). The values of “a” and “b” are determined as appropriate based on the specifications of the image capture apparatus, the voltage control response time of the voltage controller, and the like. Although the relationship “A>C>B” is employed in the present embodiment, the level “C” does not have to maintain this relationship, but can be greater than “A” (A<C), or can be smaller than “B” (B>C). In either case, the dynamic range of the A/D converter 28 can be utilized effectively if switching between the AGP driving and the on-gate driving is performed when the relationship (1) or (2) is satisfied.

Although an FT type CCD is employed as the CCD 10 in the image capture apparatus 100 according to the present embodiment, the present invention is not limited to use with an FT type CCD, but can also be applied to any other types of CCDs. For example, the present invention is applicable to controlling the amplitude of the transfer electrode voltage during transfer in an interline transfer (IT) type CCD and a frame interline transfer (FIT) type CCD, each of which has a photoelectric conversion section provided separately from the vertical shift registers.

Although, in the image capture apparatus 100 according to the present embodiment, switching between the AGP driving and the on-gate driving is performed in accordance with the intensity of light incident on the pixels, the on-gate driving at a lower frame rate maybe employed instead of the AGP driving. More specifically, switching between the on-gate driving at a normal frame rate and the on-gate driving at a lower frame rate may also be performed based on similar switching criteria. In such a case, although a lower frame rate will cause an increase in dark current, because the sensitivity can be increased, it is possible to capture a dark subject.

1. A voltage controller for a charge-coupled device having pixels provided with transfer electrodes, wherein the charge-coupled device generates and stores information charges in accordance with intensity of incident light on the pixels during image capture, transfers the information charges through application of a voltage to the transfer electrodes during transfer, and outputs an image signal in accordance with an amount of the information charges, wherein
the voltage is controlled in accordance with the intensity of incident light on the pixels to change potential of a transfer channel area, along which the information charges are transferred, and a semiconductor interface below the transfer electrodes during image capture.

2. A voltage controller according to claim 1, wherein
when the intensity of incident light is lower than a predetermined threshold light intensity, a flat band voltage is applied to all the transfer electrodes included in the pixels to perform all-gates-pinning driving.

3. A voltage controller according to claim 2, wherein
when the intensity of incident light is higher than a predetermined threshold light intensity, a voltage higher than the flat band voltage is applied to at least one transfer electrode included in each pixel to perform on-gate driving.

4. An image capture apparatus, comprising:
the voltage controller according to claim 1;
a charge-coupled device having transfer electrodes to which a voltage controlled by the voltage controller is applied; and
signal processing means including a gain adjustable amplifier and an integrator, wherein the gain adjustable amplifier amplifies a signal output from the charge-coupled device, and the integrator receives a signal output from the gain adjustable amplifier and outputs a gain signal to the gain adjustable amplifier to control signal strength of the signal output from the amplifier to a predetermined level, wherein
the voltage controller receives the gain signal, and controls the voltage based on the gain signal that is a signal corresponding to the intensity of incident light on the pixels.

5. An image capture apparatus, comprising:
the voltage controller according to claim 3;
a charge-coupled device having transfer electrodes to which a voltage controlled by the voltage controller is applied; and
signal processing means including a gain adjustable amplifier and an integrator, wherein the gain adjustable amplifier amplifies a signal output from the charge-coupled device, and the integrator receives a signal output from the gain adjustable amplifier and outputs a gain signal to the gain adjustable amplifier to control signal strength of the signal output from the amplifier to a predetermined level, wherein
the voltage controller receives the gain signal, and controls the voltage based on a level of the gain signal that is a signal corresponding to the intensity of incident light on the pixels to perform switching between the all-gates-pinning driving and the on-gate driving.

6. An image capture apparatus according to claim 5, the signal processing means further including an A/D converter, wherein the A/D converter receives the signal output from the amplifier to convert to a digital signal, wherein
when signal strength obtained by multiplying a saturation voltage output from the charge-coupled device during the all-gates-pinning driving by a gain of the amplifier is greater than a level determined by adding a predetermined amount of offset to a maximum input level of the A/D converter, the voltage controller applies a flat band voltage to the transfer electrodes to perform the all-gates-pinning driving, and
when signal strength obtained by multiplying the saturation voltage output from the charge-coupled device during the all-gates-pinning driving by the gain of the amplifier is lower than a level determined by adding a predetermined amount of offset to the maximum input level of the A/D converter, the voltage controller applies a voltage higher than the flat band voltage to the transfer electrodes to perform the on-gate driving.

7. An image capture apparatus according to claim 6, wherein the voltage controller is configured such that the amount of offset used for a transition from the on-gate driving to the all-gates-pinning driving differs from the amount of offset used for a transition from the all-gates-pinning driving to the on-gate driving.

8. A voltage control method for a charge-coupled device having pixels provided with transfer electrodes, wherein the charge-coupled device generates and stores information charges in accordance with intensity of incident light on the pixels during image capture, transfers the information charges through application of a voltage to the transfer electrodes during transfer, and outputs an image signal in accordance with an amount of the information charges, the voltage control method comprising steps of:
obtaining information regarding the intensity of incident light on the pixels; and
controlling the voltage in accordance with the obtained information regarding the intensity of incident light to change potential of a transfer channel area, along which the information charges are transferred, and a semiconductor interface below the transfer electrodes during image capture.

9. A voltage control method according to claim 8, the voltage controlling step comprising a step of:
when the intensity of incident light is lower than a predetermined threshold light intensity, applying a flat band voltage to all the transfer electrodes included in the pixels to perform all-gates-pinning driving.

10. A voltage control method according to claim 9, the voltage controlling step comprising a step of:
when the intensity of incident light is higher than a predetermined threshold light intensity, applying a voltage higher than the flat band voltage to at least one transfer electrode included in each pixel to perform on-gate driving.

11. A voltage control method according to claim 8, the method further comprising steps of:
amplifying a signal output from the charge-coupled device and outputting an amplified signal; and
receiving the amplified signal and generating a gain signal to control signal strength of the amplified signal output from the amplifying step to a predetermined level, wherein the voltage controlling step comprises a step of:
switching between the all-gates-pinning driving and the on-gate driving based on the gain signal that is a signal corresponding to the intensity of light incident on the pixels.

12. A voltage control method according to claim 11, the method further comprising a step of:
receiving the amplified signal and performing an A/D conversion to produce a digital signal, wherein the voltage controlling step comprises steps of:
when signal strength obtained by multiplying a saturation voltage output from the charge-coupled device during the all-gates-pinning driving by a gain of the amplifying step is greater than a level determined by adding a predetermined amount of offset to a maximum input level of the A/D conversion step, applying a flat band voltage to the transfer electrodes to perform the all-gates-pinning driving, and
when signal strength obtained by multiplying the saturation voltage output from the charge-coupled device during the all-gates-pinning driving by the gain of the amplifying step is lower than a level determined by adding a predetermined amount of offset to the maximum input level of the A/D conversion step, applying a voltage higher than the flat band voltage to the transfer electrodes to perform the on-gate driving.

13. A voltage control method according to claim 12, wherein, in the voltage controlling step, the amount of offset used for a transition from the on-gate driving to the all-gates-pinning driving differs from the amount of offset used for a transition from the all-gates-pinning driving to the on-gate driving.
